(19) United States
(12) Patent Application Publication
(10) Pub. No.: US 2013/0148812 A1
(43) Pub. Date: Jun. 13, 2013

(54) METHOD AND DEVICE FOR ENHANCED SOUND FIELD REPRODUCTION OF SPATIALLY ENCODED AUDIO INPUT SIGNALS

(71) Applicants: Etienne Corteel, Malakoff (FR); Matthias Rosenthal, Dielsdorf (CH)

(72) Inventors: Etienne Corteel, Malakoff (FR); Matthias Rosenthal, Dielsdorf (CH)

(21) Appl. No.: 13/818,014

(22) PCT Filed: Aug. 25, 2011
(86) PCT No.: PCT/EP11/64592

§ 371 Date: Feb. 20, 2013

(30) Foreign Application Priority Data
Aug. 27, 2010 (EP) 10174407.6

(51) Int. Cl. H04R 5/04

(52) U.S. Cl. CPC H04R 5/04
USPC 381/17

(57) ABSTRACT

A method for sound field reproduction into a listening area of spatially encoded first audio input signals according to sound field description data using an ensemble of physical loudspeakers. The method includes computing reproduction subspace description data from loudspeaker positioning data describing the subspace in which virtual sources can be reproduced with the physically available setup. Then, second and third audio input signals with associated sound field description data, in which second audio input signals include spatial components of the first audio input signals located within the reproducible subspace and third audio input signals include spatial components of the first audio input signals located outside of the reproducible subspace. A spatial analysis is performed on second audio input signals to extract fourth audio input signals corresponding to localizable sources within the reproducible subspace with associated source positioning data. Components of second audio input signals after spatial analysis are merged with third audio input signals into fifth audio input signals with associated sound field description data for reproduction within the reproducible subspace. Loudspeaker alimentation signals are computed from fourth and fifth audio input signals.

The invention relates to a method and a device for efficient 3D sound field reproduction using loudspeakers. Sound field reproduction relates to the reproduction of the spatial characteristics of a sound scene within an extended listening area. First, the sound scene should be encoded into a set of audio signals with associated sound field description data. Then, it should be reproduced/decoded on the available loudspeaker setup. There exist a increasing variety of so-called audio format (stereo, 5.1, 7.1 9.1, 10.2, 22.2, HOA, MPEG-4, . . . ) which needs to be reproduced on the available rendering system using loudspeakers or headphones. However, the available loudspeaker setup is usually not confirming to the standard of the audio format both from economical and practical constraints. The audio format may indeed require a too large number of loudspeakers that should be positioned at unpractical positions in most environments. The required loudspeaker system might also be too expensive for a large number of installations. Therefore, there is a requirement for advanced rendering methods and devices for optimizing reproduction on the available loudspeaker setup.

### DESCRIPTION OF STATE OF THE ART

In the description of the state of the art, the spatial encoding methods are described first, highlighting their limitations. In a second part, state of the art audio spatial reproduction techniques are presented.

### Encoding of Spatial Sound Scene

There exist two types of sound field description:
the object based description,
the physical description.

The object-based description provides a spatial description of the causes (the acoustic sources), their acoustic radiation characteristics (directivity) and their interaction with the environment (room effect). This format is very generic but it suffers from two major drawbacks. First, the number of audio channels increases linearly with the number of sources. Therefore, a very high number of channels need to be transmitted to describe complex scenes together with associated description data making it unsuitable for low bandwidth applications (mobile devices, conferencing, . . . ). Second, the mixing parameters are completely revealed to the users and may be altered. This limits intellectual property protection of the sound engineers therefore reducing acceptance factor of such a format.

The physical description intends to provide a physically correct description of the sound field within an extended area. It provides a global description of the consequences, i.e. the sound field, as opposed to the object-based description that describes the causes, i.e. the sources. There again exist two types of physical description:
the boundary description,
the spatial Eigen function decomposition.

The boundary description consists in describing the pressure and the normal velocity of the target sound field at the boundaries of a fixed size reproduction subspace. According to the so-called Kirchhoff-Helmholtz integral, this description provides a unique representation of the sound field within the inner listening subspace. In theory, a continuous distribution of recording points is required leading to an infinite number of audio channels. Performing a spatial sampling of the description surface can reduce the number of audio channels. This however introduces so-called spatial aliasing that introduce audible artefacts. Moreover the sound field is only described within a defined reproduction subspace that is not easily scalable. Therefore, the boundary description cannot be used in practice.

The Eigen function description corresponds to a decomposition of the sound field into Eigen solutions of the wave equation in a given coordinate system (plane waves in Cartesian coordinates, spherical harmonics in spherical coordinates, cylindrical harmonics in cylindrical coordinates, . . . ). Such functions form a basis of infinite dimension for sound field description in 3D space.

The High Order Ambisonics (HOA) format describes the sound field using spherical harmonics up to a so-called order N. (N+1)² components are required for description up to order N that are indexed by so-called order and degree. This format is disclosed by J. Daniel In “Spatial sound encoding including near field effect: Introducing distance coding filters and a viable, new ambisonic format” in 23th International Conference of the Audio Engineering Society, Helsingør, Danemark, June 2003. FIG. 1 describes the equivalent radiation characteristics of spherical harmonics for N=3. It can be seen that higher orders correspond to more complex radiation pattern in the elevation whereas higher absolute degrees induce more complex radiation pattern in the azimuthal dimension.

As any other sound field description, the HOA description is independent of the reproduction setup. This description additionally keeps mixing parameters hidden from the end users.

HOA provides however a physically accurate description in a limited area around the origin of the spherical coordinate system. This area has the shape of a sphere with radius rₘₐₓ=N/6*λ where λ is the wavelength. Therefore, a physically correct description for typical head size in the entire audio bandwidth (20-20000 Hz) would require an order 20 (i.e. 441 components). Practical use of HOA usually considers maximum orders comprised between 1 (4 channels, so-called B-format) and 4 (i.e. 25 audio channels).

HOA thus introduces localization errors and localization blur of sound events of the sound scene even at the ideal centered listening positions that are getting less disturbing for higher orders as disclosed by S. Bertet, J. Daniel, E. Parizet, and O. Warusfel in “Investigation on the restitution system influence over perceived higher order Ambisonics sound field: a subjective evaluation involving from first to fourth order systems,” in Proc. Acoustics-08, Joint ASA/EAA meeting, Paris, 2008.

The plane wave based physical description also requires an infinite number of components in order to provide an accurate description of the sound field in 3D space. A plane wave can be described as resulting from a source at an infinite distance from the reference point that is describing a fixed direction independently of the listening point. Nowadays stereophonic based formats (stereo, 5.1, 7.1, 22.2 . . . ) can be related to plane wave description using a reduced number of components. They indeed carry audio information that should be reproduced using loudspeakers located at specific directions in reference to an optimum listening point (origin of the Cartesian system).

The audio channels contained for stereophonic or channel based format are obtained by positioning virtual sources using so-called panning laws. Panning laws typically spread the energy of the audio input channel of the source on two or more output audio channels for simulating a virtual position in between loudspeaker directions. These techniques are based on stereophonic principles that are essentially used in the horizontal plane but can be extended to 3D using VBAP as disclosed by V. Pulkki in “Virtual sound source positioning using vector based amplitude panning” Journal of the Audio Engineering Society, 45(6), June 1997. Stereophonic principles create an illusion that is only valid at the reference listening point (the so-called sweet spot). Outside of the sweet spot, the illusion vanishes and sources are localized on the closest loudspeaker. Localization in height using stereophonic principals is also limited as disclosed by W. de Bruijn in “Application of Wave Field Synthesis in Videoconferencing” PhD thesis, TU Delft, Delft, the Netherlands, 2004. Localization is shown to be very imprecise and blurred.

The encoding of sound sources into spherical harmonics can also be described as equivalent panning functions using loudspeakers located on a sphere as disclosed by M. Poletti in “Three-dimensional surround sound systems based on spherical harmonics” Journal of the Audio Engineering Society, 11(53):1004-1025, November 2005. Therefore, it can be understood that HOA suffers from similar artefacts than channel based description format.

### Sound Field Reproduction Techniques

Sound reproduction techniques can be classified into two groups:
passive reproduction techniques that directly reproduce the spatially encoded signals,
active reproduction techniques that first perform a spatial analysis of the content in order to typically increase the precision of the spatial description before reproduction.

### Passive Reproduction Techniques

The first passive sound field reproduction technique described here is referred to as Wave Field Synthesis (WFS). WFS relies on the recreation of the curvature of the wave front of an acoustic field emitted by a virtual source (object-based description) using a plurality of loudspeakers within an extended listening area which typically spans the entire reproduction space. This method has been disclosed by A. J. Berkhout in “A holographic approach to acoustic control”, Journal of the Audio Eng. Soc., Vol. 36, pp 977-995, 1988. In its original description WFS is limited to horizontal sound field reproduction using horizontal loudspeaker arrays. However, WFS can readily be derived for 3D reproduction as disclosed by Munenori N., Kimura T., Yamakata, Y. and Katsumoto, M. in “Performance Evaluation of 3D Sound Field Reproduction System Using a Few Loudspeakers and Wave Field Synthesis”, Second International Symposium on Universal Communication, 2008. WFS is a very flexible sound reproduction method that can easily adapt to any convex loudspeaker array shape.

The main drawback of WFS is known as spatial aliasing. Spatial aliasing results from the use of individual loudspeakers instead of a continuous line or surface. However, it is possible to reduce spatial aliasing artefacts by considering the size of the listening area as disclosed in WO2009056508.

Channel based format can be easily reproduced using WFS using virtual loudspeakers. Virtual loudspeakers are virtual sources that are positioned at the intended positions of the loudspeakers according to the channel based format (+/−30 degrees for stereo, . . . ). These virtual loudspeakers are preferably reproduced as plane waves as disclosed by Boone, M. and Verheijen E. in “Sound Reproduction Applications with Wave-Field Synthesis”, 104^{th} convention of the Audio Engineering Society, 1998. This ensures that they are perceived at the intended angular position throughout the listening area, which tends to extend the size of the sweet spot (the area where the stereophonic illusion works). However, there remains a modification of relative delays between channels with respect to listening position due to travel time differences from the physical loudspeaker layout that limit the size of the sweet listening area.

### HOA Rendering

The reproduction of HOA encoded material is usually realized by synthesizing spherical harmonics over a given set of at least (N+1)² loudspeakers where N is the order of the HOA format. This “decoding” technique is commonly referred to as mode matching solution. The main operation consists in inverting a matrix L that contains the spherical harmonic decomposition of the radiation characteristics of each loudspeakers as disclosed by R. Nicol in “Sound spatialization by higher order ambisonics: Encoding and decoding a sound scene in practice from a theoretical point of view.” in Proceedings of the 2nd International Symposium on Ambisonics and Spherical Acoustics, 2010. The matrix L can easily be ill-conditioned, especially for arbitrary loudspeaker layouts and depends on frequency. The decoding performs best for a fully regular loudspeaker layout on a sphere with exactly (N+1)² loudspeakers in 3D. In this case, the inverse of matrix L is simply transpose of L. Moreover, the decoding might be made independent of frequency if the loudspeaker can be considered as plane waves, which is often not the case in practice.

Another solution for HOA rendering over loudspeakers is disclosed by Corteel E., Roux S. and Warusfel O. in “Creation of Virtual Sound Scenes Using Wave Field Synthesis” in proceedings of the 22^{nd} tonmeistertagung vdt international audio convention, Hannover, Germany, 2002. The reproduction of HOA encoded material is described by first decoding the HOA encoded scene into audio channels that are later reproduced through virtual loudspeakers on a real loudspeaker setup using WFS. It is recommended to reproduce virtual loudspeakers as plane waves to increase the listening area with HOA or stereophonic encoded material. The use of plane waves additionally simplifies the decoding of HOA encoded signals since the decoding matrix is then independent of frequency.

A similar technique is later described in US2010/0092014 A1. However, very few details are given the positioning of virtual loudspeakers. This patent application is more directed towards reduction of reproduction cost by realizing all movements of virtual sources in the spatially encoded format using either multichannel panning, VBAP or HOA.

Other methods: sound field optimization methods within restricted subspace

The main limitation for sound field reproduction is the required number of loudspeakers and their placement within the room. Full 3D reproduction would require placing loudspeaker on a surface surrounding the listening area. In practice, the reproduction systems are thus limited to simpler loudspeaker layout that can be horizontal as for the majority of WFS systems, or even frontal only. At best loudspeakers are positioned on the upper half sphere as described by Zotter F., Pomberger H., and Noisternig M. in “Ambisonic decoding with and without mode-matching: a case study using the hemisphere” In 2nd International Symposium on Ambisonics and Spherical Acoustics, 2010.

### Active Rendering: Upmixing

Active rendering of spatially encoded input signals has been mostly applied in the field of upmixing systems. Upmix consists in performing a spatial analysis to separate localizable sounds from diffuse sounds and typically create more audio output signals than audio input signals. Classical applications of upmix consider enhanced playback of stereo signals on a 5.1 rendering system.

Methods in prior art are first decomposing the audio signals input signals into frequency bands. The spatial analysis is then performed in each frequency band independently using different techniques:
method 1: comparing directional channels by pairs using for example real valued correlation metrics as disclosed in WO2007026025 or complex valued correlation metrics as disclosed in US20090198356;
method 2: obtaining direction and diffuseness from “Gerzon vectors”, i.e. velocity and intensity vectors for channel-based formats as disclosed in US20070269063;
method 3: using principal component analysis of the correlation matrix to extract main direction from channel based formats as disclosed in US20080175394.
method 4: computing intensity vector out of 1^{st} order Ambisonics by combining omnidirectional component and dipoles to evaluate diffuseness and direction of incidence as disclosed in US20080232616;

The first two methods are mostly based on channel-based formats whereas the last one considers only first order Ambisonics inputs. However, the related patent are describing techniques to either translate the Ambisonics format into channel based format by performing decoding on a given virtual loudspeaker setup or alternatively by considering the directions of the channel-based format as plan waves and decompose them into spherical harmonics to create an equivalent Ambisonics format.

These spatial analysis techniques all suffer from the same type of problems. They only allow for a limited precision since only one source direction can typically be estimated per frequency band. The analysis is usually performed on the full space. Strong interferers located at positions that cannot be reproduced by the available loudspeaker setup can easily disturb the analysis. Therefore, important sources located in the reproducible subspace may be missed.

### Drawbacks of State of the Art

Sound field reproduction systems according to state of the art suffer from several drawbacks. First, the encoding of the sound field into a limited set of components (channel-based encoding or HOA) reduces the quality of the spatial description of the sound scene and the size of the listening area. Second, spatial analysis procedures used in active reproduction systems to improve spatial encoding resolution are limited in their capabilities since they can only extract one source per considered frequency band. Moreover, the spatial analysis procedures don't account for the limited reproducible subspace due to the limitations of the reproduction setup in order to limit influence of strong interferers located outside of reproducible subspace and focus the analysis in the reproducible subspace only.

### Aim of the Invention

The aim of the invention is to increase the spatial performance of sound field reproduction with spatially encoded audio signals in an extended listening area by properly accounting the capabilities of the rendering system. It is another aim of the invention to propose advanced spatial analysis techniques for improving sound field description before reproduction. It is another aim of the invention to account for the capabilities of the reproduction setup so as to focus the spatial analysis of the audio input signals into the reproducible subspace and limit influence of strong interferers that cannot be reproduced with the available loudspeaker setup.

### SUMMARY OF THE INVENTION

The invention consists in a method and a device in which a reproducible subspace is defined based on the capabilities of the reproduction setup. Based on this reproducible subspace description, audio signals located within the reproducible subspace are extracted from the spatially encoded audio input signals. A spatial analysis is performed on the extracted audio input signals to extract main localizable sources within the reproducible subspace. The remaining signals and the portion of the audio input signals located outside of the reproducible are then mapped within the reproducible subspace. The latter and the extracted sources are then reproduced as virtual sources/loudspeakers on the physically available loudspeaker setup.

The spatial analysis is preferably performed into the spherical harmonics domain. It is proposed to adapt direction of arrival estimates method technique developed in the field of microphone array processing as disclosed by Teutsch, H. in “Modal Array Signal Processing: Principles and Applications of Acoustic Wavefield Decomposition” Springer, 2007. These methods enable to estimate multiple sources simultaneously in the presence of spatially distributed noise. They were described for direction of arrival estimates of sources and beamforming using circular (2D) or spherical (3D) distribution of microphones in the cylindrical (2D) or spherical (3D) harmonics.

In other words, there is presented here a method for sound field reproduction into a listening area of spatially encoded first audio input signals according to sound field description data using an ensemble of physical loudspeakers. The method comprises the steps of computing reproduction subspace description data from loudspeaker positioning data describing the subspace in which virtual sources can be reproduced with the physically available setup. Second and third audio input signals with associated sound field description data are extracted from first audio input signals such that second audio input signals comprise spatial components of the first audio input signals located within the reproducible subspace and third audio input signals comprise spatial components of the first audio input signals located outside of the reproducible subspace. Then, a spatial analysis is performed on second audio input signals so as to extract fourth audio input signals corresponding to localizable sources within the reproducible subspace with associated source positioning data. Remaining components of second audio input signals after spatial analysis are merged with third audio input signals forming fifth audio input signals with associated sound field description data for reproduction within the reproducible subspace. Finally, loudspeaker alimentation signals are computed from fourth and fifth audio input signals according to loudspeaker positioning data, localizable sources positioning data and sound field description data.

Furthermore, the method may comprise steps wherein the sound field description data are corresponding to eigen solutions of the wave equation (plane waves, spherical harmonics, cylindrical harmonics, . . . ) or incoming directions (channel-based format: stereo, 5.1, 7.1, 10.2, 12.2, 22.2). And the method may comprise steps:
wherein the spatial analysis is performed by first converting, if necessary, second audio input signals into spherical (3D) or cylindrical (2D) harmonic components; second, identifying directional of arrival/sound field description data of main localizable sources within the reproducible subspace; and forming beam patterns by combination of spherical harmonics having main lobe in the direction of the estimated direction of arrival in order to extract fourth audio input signals from second audio input signals.
wherein the sound field description data of fourth audio input signals are estimated using a subspace directional of arrival estimate method, derived for example from a MUSIC or ESPRIT based algorithm, operating in spherical (3D) or cylindrical (2D) harmonics domain.
wherein the reproducible subspace description data are computed according to the loudspeaker positioning data (4) and the listening area description data (23).

Moreover, the invention comprises a device for sound field reproduction into a listening area of spatially encoded first audio input signals according to sound field description data using an ensemble of physical loudspeakers. Said device comprises a reproducible subspace computation device for computing reproduction subspace description data from loudspeaker positioning data describing the subspace in which virtual sources can be reproduced with the physically available setup. Said device further comprises a reproducible subspace audio selection device for extracting second and third audio input signals with associated sound field description data wherein second audio input signals comprise spatial components of the first audio input signals located within the reproducible subspace and third audio input signals comprise spatial components of the first audio input signals located outside of the reproducible subspace. Said device also comprises a sound field transformation device on second audio input signals so as to extract fourth audio input signals corresponding to localizable sources within the reproducible subspace with associated source positioning data and merging remaining components of second audio input signals after spatial analysis and third audio input signals into fifth audio input signals with associated sound field description data for reproduction within the reproducible subspace. Said device finally comprises a spatial sound rendering device in order to compute loudspeaker alimentation signals from fourth and fifth audio input signals according to loudspeaker positioning data, localizable sources positioning data and sound field description data of the fifth audio input signals.

Furthermore, said device may preferably compromise elements:
wherein the reproducible subspace computation device computes the reproducible subspace description data according to the loudspeaker positioning data and the listening area description data.
wherein the spatial sound rendering device computes loudspeaker alimentation signals according to loudspeaker positioning data, the listening area description data, localizable sources positioning data and sound field description data of the fifth audio input signals.

The invention will be described with more detail hereinafter with the aid of an example and with reference to the attached drawings, in which

FIG. 1 describes the radiation pattern of spherical harmonics

FIG. 2 describes a sound reproduction system according to prior art.

FIG. 3 describes a sound reproduction system according to the invention.

FIG. 4 describes beamforming by combination of spherical harmonics of maximum order 3

FIG. 5 describes first embodiment according to the invention

FIG. 6 describes second embodiment according to the invention

FIG. 7 describes third embodiment according to the invention

### DETAIL DESCRIPTION OF FIGURES

FIG. 1 was discussed in the introductory part of the specification and is representing the state of the art. Therefore these figures are not further discussed at this stage.

FIG. 2 represents a soundfield rendering device according to the state of the art. In this device, a decoding/spatial analysis device 24 calculates a plurality of decoded audio signals 25 and their associated sound field positioning data 26 from first audio input signals 1 and their associated sound field description data 2. Depending on the implementation, the decoding/spatial analysis device 24 may realize either the decoding of HOA encoded signals or spatial analysis of first audio input signals 1. The positioning data 26 describe the position of target virtual loudspeakers 21 to be synthesized on the physical loudspeakers 3.

A spatial sound rendering device 19 computes alimentation signals 20 for physical loudspeakers 3 from decoded audio signals 25, their associated sound field description data 26 and loudspeakers positioning data 4. The alimentation signals for physical loudspeakers 20 drive a plurality of loudspeakers 3.

FIG. 3 represents a soundfield rendering device according to the invention. In this device, a reproducible subspace computation device 7 is computing reproducible subspace description data 8 from loudspeaker positioning data 4. A reproducible subspace audio selection device 9 extracts second audio input signals 10 and their associated sound field description data 11, and third audio input signals 12 and their associated sound field description data 13 from first audio input signals 1, their associated sound field description data 2 and reproducible subspace description data 8 such that second audio input signals 10 comprise elements of first audio input signals 1 that are located within the reproducible subspace 6 and third audio input signals 12 comprise elements of first audio input signals 1 that are located outside the reproducible subspace 6. A sound field transformation device 14 computes fourth audio input signals 15 and their associated positioning data 16 by extracting localizable sources from second audio input signals 10 within the reproducible subspace 6. The sound field transformation device 14 additionally computes fifth audio input signals 17 and their associated positioning data 18 from remaining components of second audio input signals 10 and their associated sound field description data 11 after localizable sources extraction and third audio input signals 12 and their associated sound field description data 13. The positioning data 18 of fifth audio input signals 17 correspond to fixed virtual loudspeakers 21 located within the reproducible subspace 6. A spatial sound rendering device 19 computes alimentation signals 20 for physical loudspeakers 3 from the fourth audio input signals 15 and their associated positioning data 16, fifth audio input signals 17 and their associated positioning data 18, and loudspeakers positioning data 4. The alimentation signals for physical loudspeakers 20 drive a plurality of loudspeakers 3 so as to reproduce the target sound field within the listening area 5.

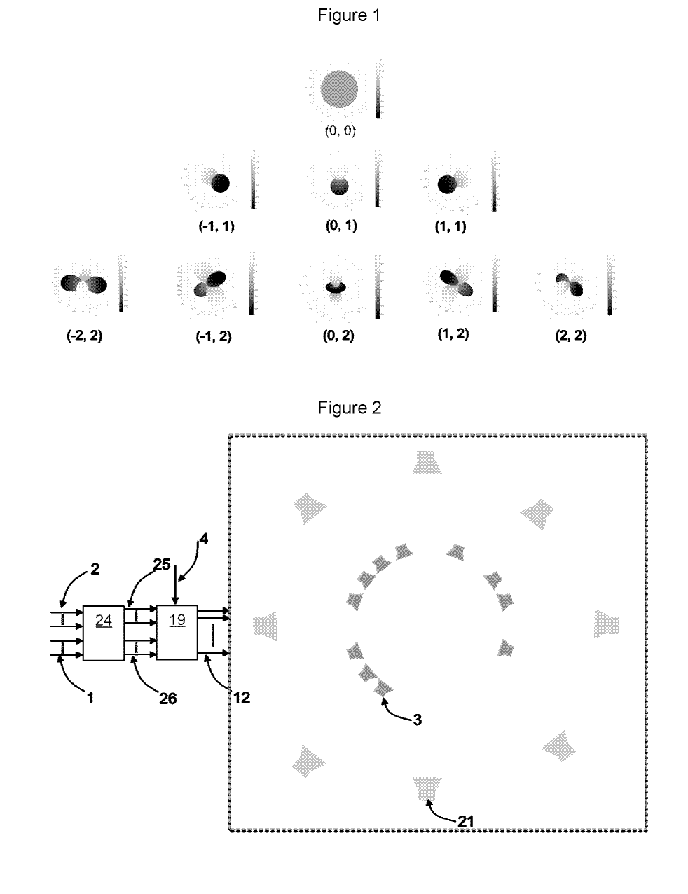

### Mathematical Foundations:

The derivations presented here are only given in the spherical harmonics domain that is adapted for describing sound fields in 3 dimensions (3D). For 2 dimensional sound fields (2D), the same derivations can be done using a limited subset of cylindrical harmonics that are independent of the vertical coordinate (z axis).

For the interior problem, where no sources are located within the listening area, the sound field radiated at a point \dot{r} (r: radius, φ: azimuth angle, θ: elevation angle) can be uniquely expressed as a weighted sum of so called spherical harmonics Yₘₙ(φ,θ) as:

$$p ( {r}^{r} , ω ) = {\sum }_{n = 0}^{+ ∞} {i}^{n} {j}_{n} ( kr ) {\sum }_{m = - n}^{n} {B}_{mn} ( ω ) {Y}_{mn} ( ϕ , θ )$$

The spherical harmonics Yₘₙ(φ,θ) of degree m and order n are given by

$${Y}_{mn} ( ϕ , θ ) = \sqrt{( 2 n + 1 ) {ɛ}_{n} \frac{( n - m ) !}{( n + m ) !}} {P}_{mn} ( sin θ ) \times \{ \begin{matrix}cos ( m ϕ ) & if m >= 0 \\ sin ( - m ϕ ) & if m < 0\end{matrix} \\ where \\ {ɛ}_{n} = \{ \begin{matrix}1 & if m = 0 \\ 2 & otherwise\end{matrix}$$

jₙ(kr) is the spherical bessel function of the first kind of order n and Pₘₙ(sin θ) are the associated legendre function defined as

$${P}_{mn} ( sin θ ) = \frac{d {P}_{n} ( sin θ )}{d {( sin θ )}^{m}}$$

where Pₙ(sin θ) is the Legendre polynomial of the first kind of degree n.

Bₘₙ(ω) are referred to as spherical harmonic decomposition coefficients of the sound field.

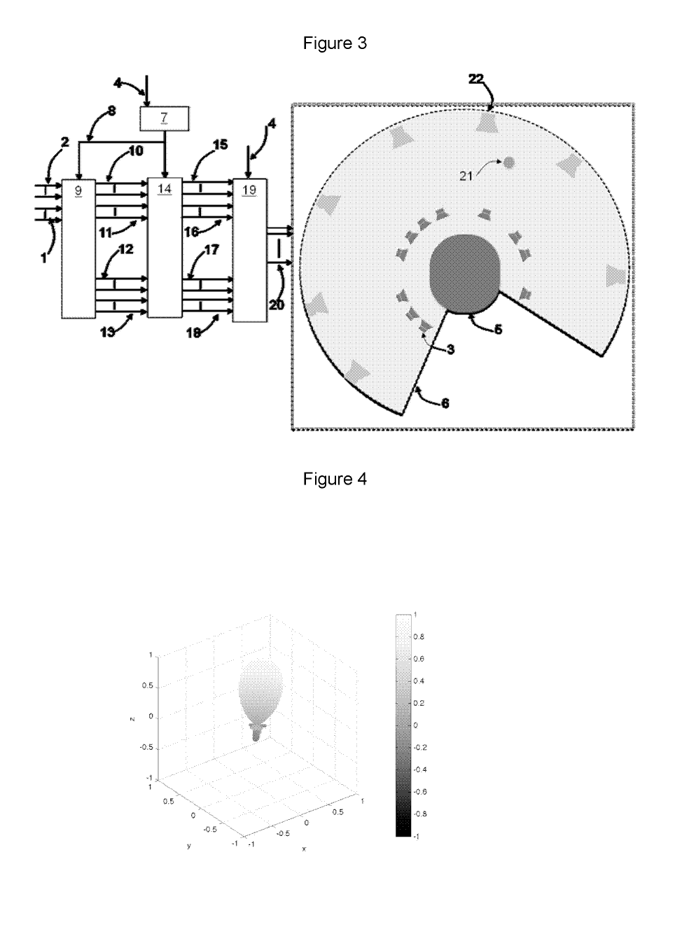

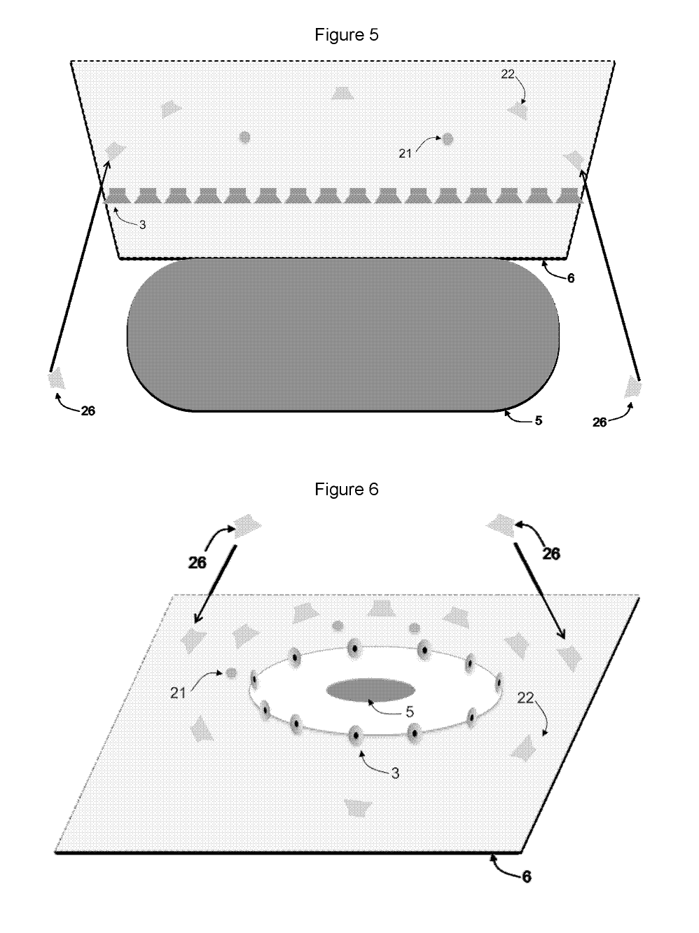

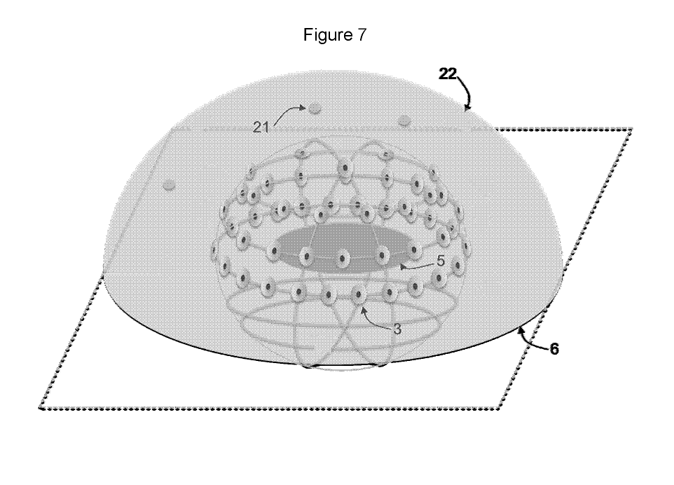

The spherical harmonics Yₘₙ(φ,θ) displayed in FIG. 3 for orders n ranging from 0 to 3 and all possible degrees. The spherical harmonics therefore describe more and more complex patterns of radiation around the origin of the coordinate system.

For a plane wave of magnitude O_{pw} originating from (φ_{pw},θ_{pw}), the spherical harmonic decomposition coefficients Bₘₙ(ω) are given by:

$${B}_{mn} ( ω ) = \frac{{O}_{pw}}{4 π} {Y}_{mn} ( {ϕ}_{pw} , {θ}_{pw} )$$

that are independent of frequency.

For a point source of magnitude O_{sw} originating from (r_{sw},φ_{sw},θ_{sw}), the spherical harmonic decomposition coefficients Bₘₙ(ω) are given by:

$${B}_{mn} ( ω ) = \frac{{O}_{sw}}{4 π} {i}^{- ( n + 1 )} \frac{{h}_{n}^{-} ( {kr}_{sw} )}{k} {Y}_{mn} ( {ϕ}_{sw} , {θ}_{sw} ) ,$$

where hₙ⁻ is the spherical Hankel function of the first kind. The spherical harmonic decomposition for a point source are therefore depending on frequency.

These coefficients form the basis of HOA encoding from an object-based description format where the order is limited to a maximum value N providing (N+1)² signals. The encoded signals form the (N+1)²*1 sized matrix B comprising the encoded signals at frequency ω.

Moreover, they are also used to describe the radiation of the N_{L} loudspeakers during the decoding process. Decoding consists in finding the inverse (or pseudo-inverse) matrix D of the N_{L}*(N+1)² matrix L that contains the Lₗₘₙ(ω) coefficients describing the radiation of each loudspeaker in spherical harmonics up to order N such that:

Uₗₛ=DB

where Uₗₛ is the N_{L}*1 matrix containing the alimentation signals of the loudspeakers.

Decoding can thus be considered as a beamforming operation where the HOA encoded signals are combined in a specific different way for each channel so as to form a directive beam in the direction of the target loudspeaker.

Such operation is described in FIG. 4 in which the combination of spherical harmonics is achieved using weights corresponding to the Bₘₙ(ω) coefficients obtained for a plane wave originating from

$$( \frac{3 pi}{4} , \frac{pi}{4} ) .$$

It shows a beam with maximum energy in the incoming direction of the plane wave and reduced level in other directions.

For the direction of arrival estimation, we consider that the spatially encoded signals are available as spherical harmonics in the matrix B(ω,κ) that is obtained using a Short Time Fourier Transform (STFT) at instant κ. We assume here that the matrix B(ω,κ) is obtained from the following equation:

B(ω,κ)=V(ω,Θ,κ)S(ω,κ)+N(ω,κ)

where B(ω,κ)=[B₁(ω,κ) B₂(ω,κ) . . . B_{M}(ω,κ)]^{T} contains the STFT transform of the M=(N+1)² signals of the HOA encoded scene, S(ω,κ)=[S₁(ω,κ) S₂(ω,κ) . . . S_{I}(ω,κ)]^{T} contains the STFT transform of the I sources signals at instant κ and frequency ω; N(ω,κ)=[N₁(ω,κ) N₂(ω,κ) . . . N_{M}(ω,κ)]^{T} contains the STFT transform of the M noise signals or diffuse filed components that are assumed to be decorrelated from the source signals.

In microphone array literature, the matrix V(ω,Θ,κ) is commonly referred to as “array manifold matrix”. It describes how each source is captured on the microphone array depending on the array geometry and the direction of incidence of the desired sources Θ(κ)=[Θ₁(κ) Θ₂(κ) . . . Θ_{I}(κ)]^{T}.

Assuming that the virtual sources are plane waves, the array manifold vector contains Bₘₙ(ω) coefficients obtained from the spherical harmonic decomposition of a plane wave of incidence Θᵢ=(φᵢ,θᵢ) up to order N. The target of direction of arrival algorithms is thus to find the direction Θᵢ=(φᵢ,θᵢ)i=1 L I for all sources of the sound scene.

A useful quantity for the direction of arrival estimation is the cross correlation matrix S_{BB}(ω,κ) that can be written as,

$$\begin{matrix}{S}_{BB} ( ω , κ ) = E \{ B ( ω , κ ) {B}^{H} ( ω , κ ) \} \\ = V ( ω , κ ) {S}_{SS} ( ω , κ ) {V}^{H} ( ω , κ ) + {S}_{NN} ( ω , κ )\end{matrix}$$

where E{ } denotes the expectation operator and H is the hermitian transpose operator. The noise spectral matrix is assumed to be S_{NN}(ω,κ)=σ_{w}²I where σ_{w}² is the variance of the noise and i is the identity matrix of size M*M.

An estimate of the spatio-spectral correlation matrix is currently obtained recursively as:

Ŝ_{BB}(ω,κ)=λ×V(ω,κ)V^{H}(ω,κ)+(1−λ)×Ŝ_{BB}(ω,κ−1)

where λε[0,1] is the forgetting factor as disclosed by Allen J., Berkeley D., and Blauert, J. in “Multi-microphone signal-processing technique to remove room revereberation from speech signals”, Journal of the Acoustical Society of America, vol. 62, pp 912-915, October 1977.

A low forgetting factor provides a very accurate estimate of the correlation matrix but is not capable to properly adapt to changes in the position of the sources. In contrast, a high forgetting factor would provide a very good estimate of the correlation matrix but would not very conservative and slow to adapt to changes in the sound scene.

It is then beneficial to decompose the estimate of the spatio-spectral correlation matrix into its eigenvalues ζₗ and its eigenvectors ξₗ, l=1 L M such that

$${\hat{S}}_{BB} = {\sum }_{l = 1}^{M} {ζ}_{l} {ξ}_{l} {ξ}_{t}^{H}$$

This eigenvalue decomposition of Ŝ_{BB} is the basis of the so-called subspace-based direction of arrival methods as disclosed by Teutsch, H. in “Modal Array Signal Processing: Principles and Applications of Acoustic Wavefield Decomposition” Springer, 2007. The eigenvectors are separated into subspaces, the signal subspace and the noise subspace. The signal subspace is composed of the I eigenvectors corresponding to the I largest eigenvalues. The noise subspace is composed of the remaining eigenvectors.

It is now useful to note that, by definition, these subspaces are orthogonal. This observation is the basis of the so-called MUSIC direction of arrival estimate algorithm. The MUSIC algorithm looks for the I array manifold vectors V(Θ) that describe best the signal subspace or are in other words “most orthogonal” to the noise subspace. We therefore define the so-called pseudo-spectrum \hat{Q}(Θ) by projecting the array manifold vector onto the noise subspace while varying directional of arrival Θ=(φ,θ):

$$\hat{Q} ( Θ ) = {V}^{H} ( Θ ) ( {\sum }_{l = I + 1}^{M} {ξ}_{l} {ξ}_{t}^{H} ) V ( Θ )$$

The Θᵢ=(φᵢ,θᵢ)i=1 L I can thus be obtained as the I minima of \hat{Q}(Θ).

This algorithm is commonly referred to as spectral MUSIC. There exist many variations of this algorithm (root-MUSIC, unitary root-MUSIC, . . . ) that are detailed in the literature (see Krim H. and Viberg M. “Two decades of array signal processing research—the parametric approach.” IEEE Signal Processing Mag., 13(4):67-94, July 1996) and are not reproduced here.

The other class of source localization algorithm is commonly referred to as ESPRIT algorithms. It is based on the rotational invariance characteristics of the microphone array, or in this context, of the spherical harmonics. The complete formulation of the ESPRIT algorithm for spherical harmonics is disclosed by Teutsch, H. in “Modal Array Signal Processing: Principles and Applications of Acoustic Wavefield Decomposition” Springer, 2007. It is very complex in its formulation and it is therefore not reproduced here.

### DESCRIPTION OF EMBODIMENTS

In a first embodiment of the invention, a linear array of physical loudspeakers 3 is used for the reproduction of a 5.1 input signal. This embodiment is shown in FIG. 5. The target listening area 5 is relatively large and it is used for computing the reproducible subspace together with loudspeaker positioning data considering the loudspeaker array as a window as disclosed by Corteel E. in “Equalization in extended area using multichannel inversion and wave field synthesis” Journal of the Audio Engineering Society, 54(12), December 2006. The second audio input signals 10 are thus composed of the frontal channels of the 5.1 input (L/R/C). The third audio input channels 12 are formed by the rear components of the 5.1 input (Ls and Rs channels). The spatial analysis is achieved in the cylindrical harmonic domain by encoding the second audio input channels into HOA with, for example, N=4. The spatial analysis enables to extract virtual sources 21 which are then reproduced using WFS on the physical loudspeakers at their intended location. The remaining components of the second audio input signals are decoded on 3 frontal virtual loudspeakers 22 located at the intended positions of the LRC channels (−30, 0, 30 degrees) as plane waves. The third audio input signals are reproduced using virtual loudspeakers located at the boundaries of the reproducible subspace using WFS.

In a second embodiment of the invention, a circular horizontal array of physical loudspeakers 3 is used for the reproduction of a 10.2 input signal. This embodiment is shown in FIG. 6. 10.2 is a channel-based reproduction format which comprises 10 broadband loudspeaker channels among which 8 channels are located in the horizontal plane and 2 are located at 45 degrees elevation and +/−45 degrees azimuth as disclosed by Martin G. in “Introduction to Surround sound recording” available at http://www.tonmeister.ca/main/textbook/. The second audio input signals 10 are thus composed of the horizontal channels of the 10.2 input. The third audio input channels 12 are formed by the elevated components of the 10.2 input. The spatial analysis is achieved on the cylindrical harmonic domain by encoding the second audio input channels into HOA with, for example, N=4. The spatial analysis enables to extract virtual sources 21 which are then reproduced using WFS on the physical loudspeakers at their intended location. The remaining components of the second audio input signals are decoded on 5 regularly spaced surrounding virtual loudspeakers 22 located at (0, 72, 144, 216, 288 degrees) as plane waves. This configuration enables improved decoding of the HOA encoded signals using a regular channel layout and a frequency independent decoding matrix. Moreover, since strong localizable sources have been extracted from the spatial analysis, the remaining components can be rendered using a lower number of virtual loudspeakers. The third audio input signals are reproduced using virtual loudspeakers located at +/−45 degrees using WFS.

In a third embodiment of the invention, an upper half-spherical array of physical loudspeakers 3 is used for the reproduction of a HOA encoded signal up to order 3. This embodiment is shown in FIG. 7. The extraction of the second audio input signals 10 and the third audio input signals 12 is realized by applying a decoding and reencoding scheme. This consists in decoding the first audio input signals 1 onto a virtual loudspeaker setup that performs a regular sampling of the full sphere with L=(N+1)² loudspeakers considered as plane waves. Such sampling techniques are disclosed by Zotter F. in “Analysis and Synthesis of Sound-Radiation with Spherical Arrays” PhD thesis, Institute of Electronic Music and Acoustics, University of Music and Performing Arts, 2009.

The second audio input channels 10 are thus simply extracted by selecting the virtual loudspeakers located in the upper half space. The sound field description data 11 associated to the second audio input channels are thus simply corresponding to the directions of the selected virtual loudspeaker setup. The remaining decoded channels therefore form the third audio input signals 13 and their directions give the associated sound field description data 14.

The spatial analysis is performed in the spherical harmonics domain by first reencoding the second audio input signals 10. The extracted sources 21 are then reproduced on the physical loudspeakers 3 using WFS. The remaining components of the second audio input signals 10 are then combined with the third audio input signals 12 to form fifth audio input signals 17 that are reproduced as virtual loudspeakers 22 on the physical loudspeakers 3 using WFS. The mapping of the third audio input signals 12 onto the virtual loudspeakers 22 can be achieved by assigning each channel to the closest available virtual loudspeakers 22 or by spreading the energy using stereophonic based panning techniques.

Applications of the invention are including but not limited to the following domains: hifi sound reproduction, home theatre, cinema, concert, shows, interior noise simulation for an aircraft, sound reproduction for Virtual Reality, sound reproduction in the context of perceptual unimodal/crossmodal experiments.

Although the foregoing invention has been described in some detail for the purposes of clarity of understanding, it will be apparent that certain changes and modifications may be practiced within the scope of the appended claims. Accordingly, the present embodiments are to be considered as illustrative and not restrictive, and the invention is not limited to the details given herein, but may be modified with the scope and equivalents of the appended claims.

1-10. (canceled)

11. A method for sound field reproduction into a listening area of spatially encoded first audio input signals according to sound field description data using an ensemble of physical loudspeakers, comprising the steps of:
computing reproduction subspace description data from loudspeaker positioning data describing the subspace in which virtual sources can be reproduced with the physically available setup;
extracting second audio input signals and third audio input signals with associated sound field description data, wherein second audio input signals comprise spatial components of the first audio input signals located within the reproducible subspace and third audio input signals comprise spatial components of the first audio input signals located outside of the reproducible subspace;
performing a spatial analysis on second audio input signals for extracting fourth audio input signals corresponding to localizable sources within the reproducible subspace with associated source positioning data;
merging remaining components of second audio input signals after spatial analysis and third audio input signals into fifth audio input signals with associated sound field description data for reproduction within the reproducible subspace; and,
computing loudspeaker alimentation signals from fourth audio input signals and fifth audio input signals according to loudspeaker positioning data, localizable sources positioning data and sound field description data.

12. The method for sound field reproduction into a listening area of spatially encoded first audio input signals according to sound field description data using an ensemble of physical loudspeakers according to claim 11, wherein the sound field description data are corresponding to eigen solutions of the wave equation: plane waves, spherical harmonics, cylindrical harmonics.

13. The method for sound field reproduction into a listening area of spatially encoded first audio input signals according to sound field description data using an ensemble of physical loudspeakers according to claim 11, wherein the sound field description data are corresponding to incoming directions in a channel-based format.

14. The method for sound field reproduction into a listening area of spatially encoded first audio input signals according to sound field description data using an ensemble of physical loudspeakers according to claim 11, wherein the spatial analysis comprises the steps of:
converting, as necessary, the second audio input signals into spherical (3D) or cylindrical (2D) harmonic components;
identifying directional of arrival/sound field description data of main localizable sources within the reproducible subspace; and,
forming beam patterns by combination of spherical harmonics having main lobe in the direction of the estimated direction of arrival in order for extracting the fourth audio input signals from the second audio input signals.

15. The method for sound field reproduction into a listening area of spatially encoded first audio input signals according to sound field description data using an ensemble of physical loudspeakers according to claim 14, wherein the sound field description data are estimated using a subspace directional of arrival estimate method.

16. The method for sound field reproduction into a listening area of spatially encoded first audio input signals according to sound field description data using an ensemble of physical loudspeakers according to claim 15, wherein the sound field description data are estimated using a subspace directional of arrival estimate method derived from a MUSIC- or ESPRIT-based algorithm, operating in spherical (3D) or cylindrical (2D) harmonics domain.

17. The method for sound field reproduction into a listening area of spatially encoded first audio input signals according to sound field description data using an ensemble of physical loudspeakers according to claim 11, wherein the computation of the reproducible subspace description data are computed according to the loudspeaker positioning data and the listening area description data.

18. The method for sound field reproduction into a listening area of spatially encoded first audio input signals according to sound field description data using an ensemble of physical loudspeakers according to claim 11, wherein the computation of loudspeaker alimentation signals is performed according to loudspeaker positioning data, the listening area description data, localizable sources positioning data and sound field description data.

19. An apparatus device for sound field reproduction into a listening area of spatially encoded first audio input signals according to sound field description data using an ensemble of physical loudspeakers, comprising:
a reproducible subspace computation device for computing reproduction subspace description data from loudspeaker positioning data describing the subspace in which virtual sources can be reproduced with the physically available setup;
a reproducible subspace audio selection device for extracting second audio signals and third audio input signals with associated sound field description data, wherein the second audio input signals comprise spatial components of the first audio input signals located within the reproducible subspace and the third audio input signals comprise spatial components of the first audio input signals located outside of the reproducible subspace;
a sound field transformation device on second audio input signals for extracting fourth audio input signals corresponding to localizable sources within the reproducible subspace with associated source positioning data and merging remaining components of the second audio input signals after spatial analysis and the third audio input signals into fifth audio input signals with associated sound field description data for reproduction within the reproducible subspace; and,
a spatial sound rendering device for computing loudspeaker alimentation signals from fourth input signals and fifth audio input signals according to loudspeaker positioning data, localizable sources positioning data and sound field description data.

20. The apparatus device for sound field reproduction into a listening area of spatially encoded first audio input signals according to sound field description data using an ensemble of physical loudspeakers according to claim 19, wherein the reproducible subspace computation device computes the reproducible subspace description data according to the loudspeaker positioning data and the listening area description data.

21. The apparatus device for sound field reproduction into a listening area of spatially encoded first audio input signals according to sound field description data using an ensemble of physical loudspeakers according to claim 19, wherein the spatial sound rendering device computes loudspeaker alimentation signals according to loudspeaker positioning data, the listening area description data, localizable sources positioning data and sound field description data.
